(19) United States
(12) Patent Application Publication
(10) Pub. No.: US 2022/0398635 A1
(43) Pub. Date: Dec. 15, 2022

(54) HOLISTIC ANALYSIS OF CUSTOMER SENTIMENT REGARDING A SOFTWARE FEATURE AND CORRESPONDING SHIPMENT DETERMINATIONS

(71) Applicant: Airbnb, Inc., San Francisco, CA (US)

(72) Inventors: Kevin Jungmeisteris, Bellevue, WA (US); Artem Kizil, Seattle, WA (US); Jonathan Li On Wing, Issaquah, WA (US); Hui Wang, San Francisco, CA (US); Bo Zeng, Seattle, WA (US); Ying Zhang, Palo Alto, CA (US); Yufeng Zhang, Redmond, WA (US); Cen Zhao, Foster City, CA (US)

(73) Assignee: Airbnb, Inc., San Francisco, CA (US)

(21) Appl. No.: 17/751,376

(22) Filed: May 23, 2022

Related U.S. Application Data
(60) Provisional application No. 63/191,842, filed on May 21, 2021.

(51) Int. Cl. G06Q 30/02; G06Q 50/00

(52) U.S. Cl. CPC G06Q 30/0282; G06Q 30/0203; G06Q 50/01; G06Q 30/0204

(57) ABSTRACT

A preliminary software feature is applied in a testing rollout to a discrete subset of customers. Survey data may be collected from those customers through a variety of sources, such as chatbot text, session workflow, historical user data, social media data, email survey data, user profile data, messaging threads, and the like. This survey data is analyzed using machine learning algorithms to derive the meaning of input text as well as to determine the user sentiment expressed therein. The outputs of this analysis are normalized across sources and aggregated at a feature-level to generate overall metrics of customer satisfaction with the feature. A holistic analysis is performed on this customer sentiment data to obtain an aggregate or combined user satisfaction score. This score is applied against a set of guardrails to determine whether to ship the feature to a broader customer base.

### BACKGROUND

Web or application-implemented systems that allow for direct customer engagement often use customer support systems that seek feedback through survey data. These web or cloud-based systems may help users perform a limitless variety of tasks, a common one being e-commerce websites that permit users to buy, rent, or reserve products and/or services. Typically, the customer user of such a site performs such tasks (e.g., purchasing) themselves, using the website as a tool for facilitating the transaction. In one method of feedback, after a customer interacts with a customer support agent, a customer support system may deliver post-interaction surveys to their customers via email, SMS, or other means. Other methods may include intercept surveys presented during the user's engagement with the website or application. These surveys often pop up a standard or default question (such as “do you require any assistance?”) in a chat application or bot, for example after the user has been on a website for a predetermined amount of time. Similarly, persistent surveys, such as a “provide feedback” button or option that is constantly present on a screen, may be used. Surveys may routinely be used where new products or features are presented to users, as the software owner may seek feedback to drive their product related decisions.

A customer's answers to these surveys are typically entered via static forms or decision trees with preset responses in the selected branch being delivered in order to a user. Such surveys often contain numeric or multiple choice options for feedback, and in some cases, an option for freeform text suggestion or comment. The survey results are recorded, and basis aggregation can be performed thereon.

However, the surveys may not pull in accurate or complete information. Initially, customer participation in a voluntary survey or chat is typically very low. This is particularly true when there is a channel shift between the customer experience and the survey (e.g., website to email). Thus, any feedback received may not necessarily be accurate for extrapolation to the larger customer population. Among the customers that do respond, the participants are overwhelmingly those that are upset or unhappy with customer service, leading to skewed results. Aggregated data, based on these surveys, is slow to collect, as customers may not be interested or motivated in providing a timely response.

Further, in conventional solutions, aggregation of survey data is limited to structured data provided with the feedback, like ratings or selections, ticket groupings (e.g., product or severity), and the like. Unstructured data is absent or separately displayed, and therefore the overall view of the feedback is incomplete. Even where a customer submits a conventional survey, the information therein may not be valuable or actually indicative of the user's level of satisfaction. Metrics captured in survey data are conventionally directed to measurable data such as a number of tickets (complaints), a number of visits, a number of purchases, and so on. Typically, these metrics, such as Net Promoter Score (NPS) are tied to business growth or commercial success, however they are the sole metric available by which customer support can be assessed. The conventionally-collected business may allow for inferences into whether the technical offerings of the computer system are commercially successful, however, such metrics do not actually indicate whether the customer was happy or satisfied with the process. That is, industry-standard customer service metrics like NPS may not provide an accurate view into customer happiness.

Technical solutions for more dynamic, accurate, and timely customer sentiment analysis are therefore generally desired.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1 is a diagram of an environment including a sentiment analysis system with some embodiments of the present disclosure.

FIG. 2A is a block diagram of select component parts of a customer support system in accordance with some embodiments of the present disclosure.

FIG. 2B is a diagram of an exemplary data storage structure for data relating to a sentiment analysis and/or workflow analysis in accordance with some embodiments of the present disclosure.

FIG. 3 is an exemplary graphical user interface in accordance with some embodiments of the present disclosure.

FIGS. 4A, 4B, 4C, and 4D are an exemplary graphical user interfaces in accordance with some embodiments of the present disclosure.

FIG. 4E is a diagram of an exemplary communication flow between components of a customer support system in accordance with some embodiments of the present disclosure.

FIG. 5 is an exemplary flowchart of a text-based customer support evaluation process in accordance with some embodiments of the present disclosure.

In the figures, the left-most digit(s) of a reference number identifies the figure in which the reference number first appears. The use of the same reference numbers in different figures indicates similar or identical items or features. Moreover, multiple instances of the same part are designated by a common prefix separated from the instance number by a dash. The drawings are not to scale.

### DETAILED DESCRIPTION

The methods and systems described herein may be used to collect customer feedback and leverage sentiment analysis as a proxy to determine customer satisfaction with a service or customer support interaction. In particular, a numeric or categorical sentiment score is derived and updated in real-time based on implicit signals of customer satisfaction obtained from a user's freeform text and selection interaction with an survey, such as a chatbot, intercept survey, email survey, or another survey type presented on any one of various channels. User sentiment may be measured through surveys collected across multiple channels, and an aggregated or unified sentiment score may be determined to present a holistic view of customer satisfaction across a platform.

In some embodiments, when data is collected through a real-time chatbot or intercept survey, a sentiment score derived from a customer's input can be used as a real-time Net Promoter Score (NPS)

In some embodiments, a preliminary software feature is applied during a testing process to a discrete set of users among the broader universe of users accessing a system platform. A sentiment analysis is performed based on feedback collected from those users, as well as control users. In some embodiments, sentiment data may be generated from a variety of sources, such as real-time chatbot text, session workflow data, historical user data, social media data, email or alternate source survey data, user profile data, host/guest or seller/purchaser message threads, or the like. The generated sentiment metrics are used in an aggregated analysis of customer satisfaction specific to the preliminary software feature. More specifically, a holistic analysis is performed on this sentiment data collected from various channel sources, and is applied against a set of guardrails to determine whether to ship the feature to the broader customer base.

In an exemplary embodiment, sentiment can be mapped to business activity. Through a machine learning analysis, the support topic and sentiment expressed in a freeform user text can be identified, and the support topic matched to an outstanding or upcoming business activity.

In an embodiment, a user accessing a website may initiate communication with a customer support application or widget, by either clicking on a support feature or responding to a presented customer support inquiry. In particular, the user may input a character string (e.g., as freeform text) with the intent of receiving a responsive message or instruction. The input character string is transmitted (in some embodiments, the string being tokenized, and in others, not being tokenized) from a user device to a web server, and then to a sentiment analysis system. In some embodiments, the sentiment analysis system is capable of performing semantic parsing to capture the meaning of the input text. The sentiment analysis system includes a pre-trained natural language processing (NLP) model capable of generating vector representations of the input text. In an exemplary embodiment, the model is capable of generating a series of vectors (each corresponding to a word) so as to be representative of a sentence, or another measurement of text.

In an exemplary embodiment, a sentiment analysis is done based on the user's natural language text entered into the intercept survey to understand the meaning of the statement, request, or question input by the user. In addition, the user's relative happiness or satisfaction at the time they input the text may be gauged by a sentiment analysis. For each user response, a sentiment score is dynamically determined and/or any change of user sentiment is determined as a Δ (delta) sentiment score from the previously calculated sentiment score(s). By these means, a sequence of sentiment scores is obtained over the course of a chat conversation at a fine level of granularity, and can be used at different levels of aggregation to take one or more actions or generate reports.

An aggregated or universal customer satisfaction score may be developed based on this sentiment data. In some embodiments, the aggregated customer satisfaction score may be viewed both specific to a group of customers experiencing a particular product or feature and as compared to the customer satisfaction of a control group. Any metrics derived from such comparison can be normalized over multiple channels (e.g., email, chat) through which survey feedback is collected. This data can be compared to predetermined guardrail metrics. Accordingly, automated self-solve mechanisms can be put into place to determine whether a product or feature should be pursued, or shipped, or other business decisions should be taken thereon.

In an exemplary embodiment, in addition to the sentiment analysis, the application of a customer satisfaction score to one or more guardrails may include a rules-based contextual analysis, based on, e.g., user profile data, user history data, session workflow data or the like. As just one example, the system may determine whether a user's intended (or predicted) workflow was ultimately completed within the session before or after a customer support interaction. The number, timing, and/or flow of screens visited by the customer after their customer support interaction in the completion of the workflow can be used to determine whether a heavily manual lift (that is, self-service action by the customer) was needed after the customer support interaction as a further evidence of customer satisfaction, and a further dimension upon which satisfaction metrics can be sliced.

In one embodiment, the computer system may be an online reservation system that displays to potential customers properties, such as houses, condominiums, rooms, apartments, lots, and other real estate, offered to the potential customer (or guest) by an owner/manager of the property for reservation (sometimes referred to as a “booking” or “rental”) for a specified time period (e.g., a day, week, month, or another period of interest). The owner of a property may contract with the merchant managing the online reservation system to use the system to display a property “listing” for the reservable property. When a customer books a property, the merchant's online reservation system may allow for intake, from the customer, of a booking fee, an initial setup fee, a recurring fee, no fee, and/or any other appropriate value. In some instances, the merchant may also handle and/or facilitate one or more financial transactions relating to the purchase or booking of that property, and may receive a fee in relation thereto. The systems and methods described herein are of course not limited to systems relating to property listings; rather, they may be provided for any website, application, or e-commerce system that may potentially provide text-based customer support features.

In conventional solutions for customer support, the ability to measure customer feedback was highly dependent on manual evaluation. For example, raw information may be collected from survey results, but this data must be manually reviewed and categorized, except for the very broadest levels of classification (such as ticket type or product name, etc.). Such a process is prone to human error and interpretative bias. Survey data is conventionally presented to a user in the form of email surveys (after a customer support interaction), intercept surveys (typically triggered by elapsed time or page hit), and so on, each of which require a user to initiate (e.g., click) and fill out information well after the completion of a customer service interaction. Typically, the outcomes of these surveys will suffer from survey bias, where participants are overly pessimistic, and low engagement rate across the user population. Additionally, for email surveys, there is often a delay between the time of interaction and the time the user sends the survey. Further, a survey forces a channel shift for a user on a website or application or speaking to a customer support person by phone. While data can be aggregated from such surveys , the aggregation is limited to structured input by the customer, such as a rating or selection. As a result, the data collected and aggregated from such surveys may be insufficient, non-thorough, or inaccurate.

In contrast to conventional solutions, the systems and methods described herein allow for higher user response rate, reduction of bias, and reduction of delay in the collection and analysis or survey results. Further, the customer support system and methods described herein may target users over various or multiple channels, such as a website or application's help center (or help/feedback widget), chat function or bot (also referred to herein as a chatbot), and/or messaging features. Accordingly, the user is more likely to have access to a survey element within the channel they are currently occupying and acting within (e.g., a website), leading to faster and more accurate responses. In the systems and methods described herein, even if a user chooses not to participate in a survey, accurate and useful metrics regarding their satisfaction can still be collected based on their measured activity and workflow on and through the computing system.

Further in contrast to conventional solutions, the systems and methods described herein providing multiple feedback collection and analysis mechanisms within a single platform, so as to build data sets with several points of information on customer feedback and customer action, thereby providing a holistic view of the success of and happiness with customer-facing products and services across the given customer community. The metrics produced can be used to drive business, operational, and product decisions.

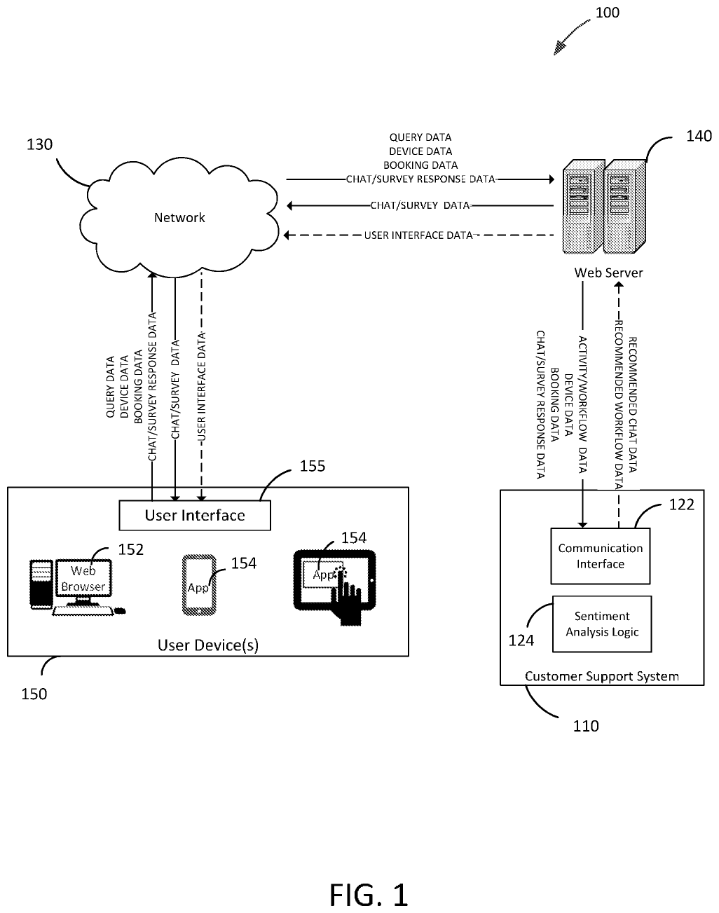

FIG. 1 depicts a block diagram of an environment 100 including a customer support system 110 in accordance with some embodiments of the present disclosure. The components of environment 100 relate to systems, methods, and interfaces for collecting customer feedback from various channels, analyzing the customer sentiment expressing therein, and aggregating the sentiment data such that metrics can be generated at various levels of granularity and focus. In the embodiment of FIG. 1, customer support system 110 is managed or facilitated (and in some embodiments owned) by a service provider. The service provider may be generally understood as an individual, entity, or organization that displays or delivers to an end user (a customer) information and/or user interfaces to allow the user to select, view, and/or access electronic content. The systems and methods described herein may be provided for any type of service provider offering a customer-facing interface that can take in customer feedback in at least text form (or in a manner than can be converted to text, such as voice-to-text).

In some embodiments, the customer support system 110 may provide support for an online reservation system that displays listings of properties, such as houses, condominiums, rooms, apartments, lots, and other real estate that are owned by different respective hosts, and that have been offered for reservation and that may be reserved for a specified time period (e.g., a day, week, month, or other window of interest) by a guest. In such embodiments, a product can be understood as a reservation for a particular physical property during a particular range of time (e.g., a day or set of days). Other embodiments are not limited to property rental, or to any other particular purpose or industry.

FIG. 1 illustrates that environment 100 may include one or more of devices connected to a network 130. Network 130 may include one or more network types, such as a wide area network (such as the Internet), a local area network (such as an intranet), a cellular network or another type of wireless network, such as Wi-Fi, Bluetooth, Bluetooth Low Energy, and/or other close-range wireless communications, a wired network, such as fiber optics and Ethernet, or any other such network, or any combination thereof. In some embodiments, the network 130 may be the Internet and payment and information may be communicated between system components in an encrypted format such by a transport layer security (TLS) or secure socket layer (SSL) protocol. In addition, when the network 130 is the Internet, the components of the environment 100 may use the transmission control protocol/Internet protocol (TCP/IP) for communication.

As shown in FIG. 1, a sentiment analysis logic 124 may be implemented by a customer support system 110 or other type of device or system that is connected to a network 130 via at least one communication interface 122. Additionally connected to network 130 is at least one web server 140 (which in some embodiments may be part of a system that also houses or is integral with the customer support system 110). In embodiments where any of customer support system 110 and/or web server 140 are owned or managed by the same entity, system 110 and server 140 may be connected through one or more networks internal to the entity's system, and in other embodiments they may be connected via network 130 (not specifically shown), where network 130 may be, in such embodiments, the Internet or any other publicly accessible network. In other embodiments, the web server 140 may be any computer system from which customer support system 110 may pull information, including, e.g., survey data entered by an end user. In some embodiments, customer support system 110 may collect such information from web server 140 via network 130.

As shown in FIG. 1, web server 140 is communicably accessible to users via their user devices 150. For instance, web server 140 may receive survey data from and/or transmit data to one or more user devices, referred to herein individually or collectively as user device(s) 150. A user device 150 may be used by individuals or entities to access, view, and/or take action in response to content delivered to the user from the web server 140. A user device 150 may include, among other things, one or more computing devices, such as a smartphone or other hand-held device (e.g., a tablet or reader), desktop computer, laptop computer, touchscreen device, or any other appropriate device capable of receiving, processing, and outputting digital information via network 130. In an exemplary embodiment, the device 150 presents information to a user via a display on, in, or connected to the device 150, and takes input from the user in relation thereto (for example, through interactive graphics or hyperlinks) via a touchscreen, mouse, keyboard, stylus, or any other appropriate input device.

In the illustrated embodiment, each user device 150 may have installed a web browser 152 and/or other appropriate applications (apps) 154 that can be used to communicate (receive and transmit data) with the system 110 and/or web browser 140 via the network 130. In some embodiments, an app 154 may be a mobile application or other software application distinct from a generic web browser, such as an e-mail, messaging, or social media application, an application specific to the e-commerce business, or another program capable of receiving digital content from the e-commerce processing server 110 and delivering such content to the user device 150. In some embodiments, the user device 150 may present to the user a user interface 155 (e.g., a graphical user interface) through app 154 or web browser 152 allowing for the entering and transmitting of information. Such information may include any of text, pictures, account information, location information, payment information, and other selections or entered information.

Web server 140 may present different types of data on the user interface 155. For instance, user interface 155 may provide an interface (in some implementations, generated and/or delivered by the web server 140) through which a user can view and/or otherwise access the content of one or more screens, messages, or forms, and through interaction with the user interface, can input, create, edit, revise, and/or delete content, such actions affecting changes displayed to the user and transmitted to the web server in real time via the interface. While FIG. 1 illustrates a one-to-one correspondence between a user device and one of a web browser 152 or app 154, the embodiments are not so limited. The digital content transmitted to the user devices 150 from web server 140 may include, e.g., textual content data, formatted webpages/user interfaces, hyperlinks, images, notifications, suggestions, and/or modifiable document representations.

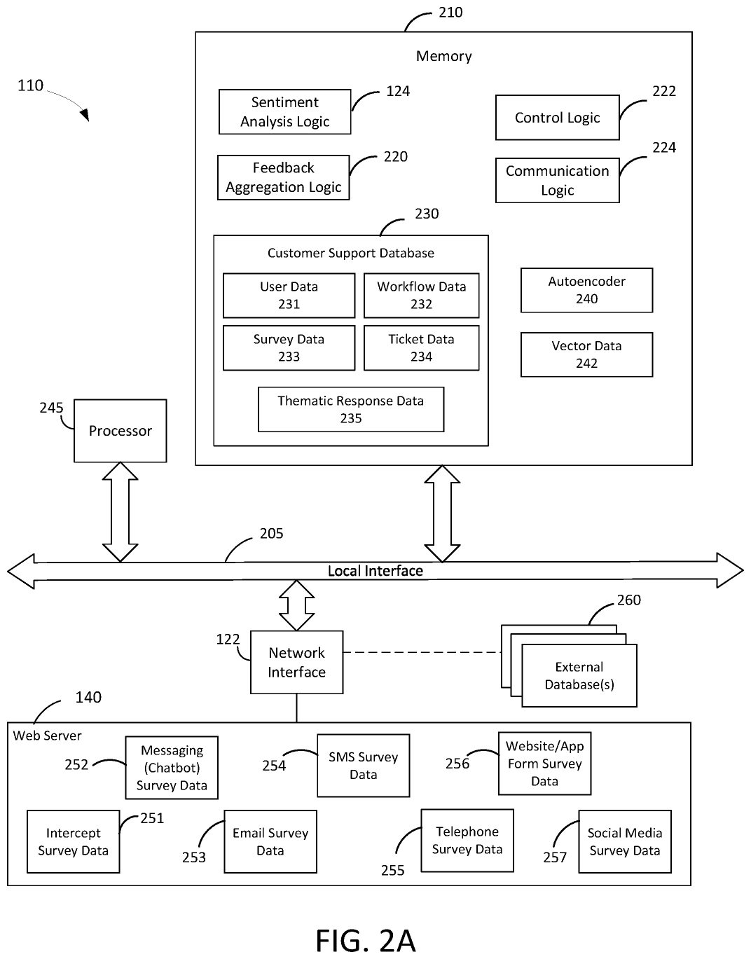

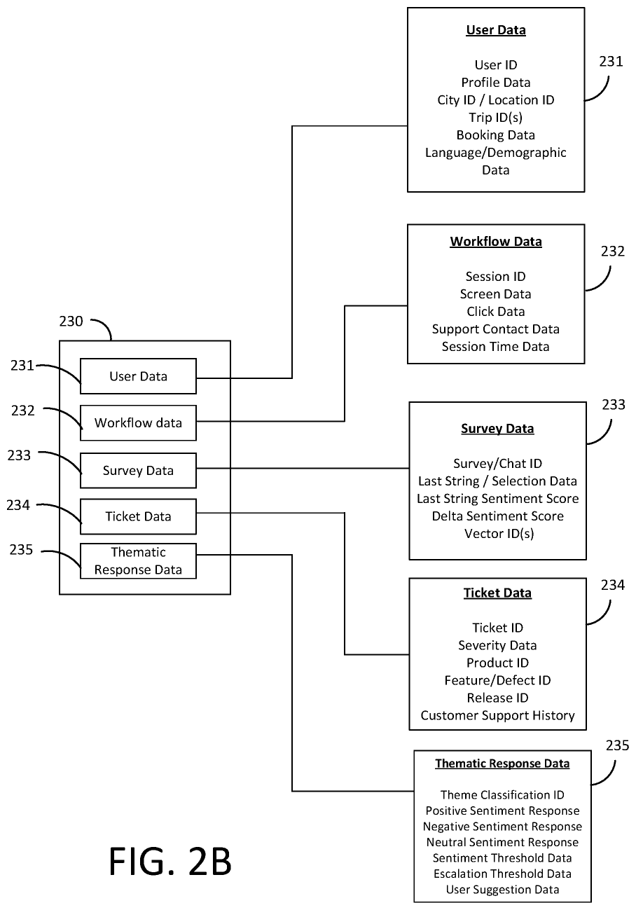

In some embodiments, web server 140 transmits to the user device 150 a user interface that can take in a freeform textual input by the user. In other embodiments, the user may enter a structured input for search, or may input any combination of freeform, structured, or unstructured input. Customer support system 110 may function to, in response to receiving this information, analyze the content and sentiment of the input and retrieve or pull, from a corpus of response data stored in one or more databases within or communicably accessible to the system 110 (e.g., customer support database 230 as shown in FIG. 2A), a set of one or more records with that contain sentences (character strings) and other data that are most responsive to the user's input. This data might include hyperlinks, document links, instructions, images, videos, selection options (e.g., boxes or radio buttons) that are selectable by a user, or other information that can direct the user's activity and/or attention. The textual content sent to the user may be a textual response to a query or statement (in some embodiments authorized and/or authored by the system 110), and/or a hyperlink to another web-based location that the user can click to address an expressed customer support problem, or the like. The suggested responses may not always be dynamically generated, but may be dynamically selected from a database in response to the words or selections of the user's freeform or structured input so as to be contextually or topically associated with the content of that input. That is, the contextual and semantic meaning of the user's text can be taken into account in providing a real-time response to a support inquiry from a user (e.g., in a web-based interface or chat window). The response is content-related and sentiment related to the user input without limiting the user to predefined selections that would guide them down a preset tree of responses.

FIG. 2 depicts an example schematic diagram of certain components of customer support system 110 in accordance with some embodiments of the present disclosure. The customer support system 110 may include a memory 210. As used herein, memory 210 may refer to any suitable storage medium, either volatile and non-volatile (e.g., RAM, ROM, EPROM, EEPROM, SRAM, flash memory, disks or optical storage, magnetic storage, or any other tangible or non-transitory medium) that stores information that is accessible by a processor. Memory 210 may store instructions and data used in the systems and methods described herein. While FIG. 2A illustrates discrete components corresponding to memory 210 and customer support database 230, it will be understood that the embodiments described herein are not limited to any particular arrangement and that other embodiments may store information in one combined memory, in one or more memories, some local to the other components illustrated in FIG. 2A and/or some shared with, or geographically located near, other remote computing systems.

As illustrated in FIG. 2A, memory 210 contains sentiment analysis logic 124 and feedback aggregation logic 220, as well as an autoencoder 240. Memory 210 may also contain control logic 222, including one or more algorithms or models for generally controlling the operation of the customer support system 110 and communication logic 224 for communicating between various components illustrated in FIGS. 1 and 2A. These depicted logics may variously represent one or more algorithms, computational models, decision making rules or instructions, or the like implemented as software code or computer-executable instructions (i.e., routines, programs, objects, components, data structures, etc.) that, when executed by one or more processor(s) 245, program the processor(s) to perform the particular functions of their respective logic. These logics are depicted in FIG. 2A as several discrete components, each labelled individually, however, in various embodiments, the functions of each respective logic may be executable on their own or as part of one or more other modules; that is, any configuration of the depicted logical components may be used, whether implemented by hardware, software, firmware, or any combination thereof. The capabilities of these various logics are described in greater detail below.

The system 110 may include control logic 222, including one or more algorithms or models for generally controlling the operation of the system 110. The memory 210 may also, in one embodiment, include communication logic 224, including one or more APIs for obtaining information from or communicating information with database 260 (or other external or third party databases) and obtaining survey data 251-257 from web server 140 and/or via network 130 (FIG. 1). The system 110 may, via communication interface 122, operate to exchange data with various components and/or devices on the network 130 or any other network. For instance, communication interface 122 and communication logic 224 may be used (by, e.g., sentiment analysis logic 124 and/or feedback aggregation logic 220 in the manner(s) described in greater detail below), to access data from web server 140. In some embodiments, communication logic 224 may use application programming interfaces (APIs) provided by web server 140 to obtain stored data, however, other methods of data collection may alternatively be used such as one or more software development kits, which may include, e.g., APIs, web APIs, tools to communicate with embedded systems, or any other appropriate implementation.

While communication logic 224 is illustrated as being a separate logical component, in an alternative embodiment, the system 110 may include communication logic 224 as part of sentiment analysis logic 235, feedback aggregation logic 220, or control logic 222. In another alternative embodiment, the communication logic 224 may communicate with third-party systems and/or may coordinate with the control logic 222 to read or write data to memory 210, or to another data repository (not shown) within or accessible to the system 110.

In some embodiments, system 110 may be implemented in whole or in part as a machine learning or deep learning system (e.g., neural network software, such as a Convolutional Neural Network (CNN)) or other rules-based system for achieving the functionalities described herein. In one embodiment, one or more of sentiment analysis logic 124, feedback aggregation logic 220, or autoencoder 240 or any subset of any of those logics) may be implemented at least in part as one or more machine learning algorithms. For instance, autoencoder 240 may be understood as a type of artificial neural network used to produce encodings (e.g., vectors) representative of features in a set of data in an unsupervised manner. In general, autoencoder 240 may include one or more machine learning models for dimensionality reduction of text and one or more machine learning models for reconstructing (generating a representation close to the original text from the reduced encoding).

While, in the exemplary embodiment, each of sentiment analysis logic 124, feedback aggregation logic 220, autoencoder 240, control logic 222, and communication logic 224 is depicted as part of customer support system 110, these logical components need not be so configured, and in other embodiments, other configurations of the various components, within system 110 or distributed over one or more computing systems, are possible. Sentiment analysis logic 124, feedback aggregation logic 220, autoencoder 240, control logic 222, and communication logic 224 may be variously implemented in software, hardware, firmware or any combination thereof. In the exemplary system 110 shown in FIG. 2A, these logics are implemented in software and are stored in memory 210. Note that these components, when implemented in software, can be stored and transported on any non-transitory computer-readable medium for use by or in connection with an apparatus (e.g., a microprocessor) that can execute instructions. In the context of this disclosure, a “computer-readable medium” can be any device or system that can contain or store a computer program for use by or in connection with an instruction execution apparatus.

The logics of the exemplary customer support system 110 depicted in FIG. 2A may be executed by one or more processors 245, such as one or more central processing units (CPU), digital signal processors (DSP), graphics processing units (GPU), application-specific integrated circuits (ASICs), field-programmable gate arrays (FPGAs), and/or microprocessors programmed with software or firmware, other specialized processor or combination of processors, or other circuitry that communicates to and drives the other elements within the system 110 via a local interface 205, which can include at least one bus, such as 120, SPI, USB, UART, or GPIO. As an example, the processor 245 may execute instructions of software stored in memory 210, or subsets thereof. While FIG. 2A illustrates one processor 245 that implements all of the various logics in the system 110, it is possible in other embodiments for the system to employ multiple processors. In one such alternate embodiment, discrete processing elements may be used for each of (or any subset of) sentiment analysis logic 124, feedback aggregation logic 220, autoencoder 240, control logic 222, and communication logic 224, or any portions or subsets of those logics. In some embodiments, the processing of system 110 is not limited to being performed by a processing element connected to the local interface 205, but instead, any portion of processing in support of the various logics or models may be distributed over one or more computer systems that may be remotely located. For instance, system 110 may include physical computing devices residing at a particular location or may be deployed, wholly or partially, in a cloud computing network environment. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). In some embodiments, the processor 245 may include an artificial neural network or other type of configuration for performing machine learning functions based on instructions stored in memory 210.

Memory 210 may also contain user data 231, workflow data 232, survey data 233, ticket data 234, thematic response data 235, and vector data 242, which respectively include one or more databases storing information used by sentiment analysis logic 124, feedback aggregation logic 220, control logic 222, and/or communication logic 224. It will be noted that while the term “database”, “data”, “repository”, or “data storage” may be used herein with reference to elements 210, 230-235, or 242 or the data structures therein, these components are not so limited nor is any particular form, number, or configuration of data storage mandated, and any of the described “databases” may alternatively be an indexed table, a keyed mapping, or any other appropriate data structure or repository.

Each of the data in repositories 231-235 will be described below in turn with reference to FIGS. 2A and 2B. In FIG. 2B, five categories of data 231-235 are illustrated, each corresponding to one or more tables or other data structures that can be queried. Other embodiments may include any number of categories, and any number of data structures. In an exemplary embodiment, the data between items 231-235 may include some amount of redundancy, as some user actions may be relevant to several categories of data, however in other embodiments, the data is unique to each category 231-235.

With reference to FIG. 2B, user data 231 may include information associated with a user, e.g., user ID, user account information (e.g., name, contact information (e.g., email address, mailing address, telephone number, date of birth, payment card information)), a type of user (e.g., guest/registered, business/vacation travelers, etc.), length of membership, booking or purchase history, demographic data about the user, such as age, gender, location, language, and device information, GPS, IP address, or location data, operating system, browser, or other device data, user preferences or interests, connected third party accounts (e.g., social networks) if applicable, and the like.

Workflow data 232 includes a variety of information collected as each user interacts with a website or app, enters data, makes transactions, and the like. Therefore, each of the entries in workflow data 232 can be associated with a particular user or user device, for example, a user ID (if logged in), a device (by device ID, IP address, MAC address, or the like), session ID, other information sufficient to identify a user (such as a unique code or password), or any other appropriate identifying mechanism. By these means, workflow data 232 can be aggregated per user, for a given period of time, to determine cumulative or summary data for a particular user or set of users, for example a set of users selected for a trial of a product of software feature, the users sharing a characteristic (e.g., customer support ticket topic). In an exemplary embodiment, data regarding a user's activity and interaction is pulled from one or more of web server(s) 140 and external databases 260 to populate workflow data 232 in real-time, in response to any action by the user or any of one or more scheduled events. Alternatively, data may be pulled on a scheduled basis, e.g., every one or five minutes, or any other appropriate frequency. In some embodiments, the selected method and frequency of data collection may depend on server computing resources, transmission latency, frequency of activity in the relevant market, a user base size, seasonality or changeability of data, and/or other relevant considerations.

Workflow data 232 may also include landing data, that is, an entry point for a user such as a first landing page displayed to a user when accessing a website or app, upon which landing a unique session or workflow ID is created. The landing data and the data of any other screen or user interface interacted with or visited by the user may be referred to as screen data. Where the user interacts with fields of data such as hyperlinks, buttons, search bars, filters, pop-ups or persistent messages, chat features or messaging options, drop down menus, search fields, radio buttons, maps, sliders, point-and-click interfaces, or other user interface components, this data may be stored as click data in database 232. In some embodiments, web server logs may contain information that allow sites to determine what sites referred the visitor to the present site, what pages a visitor viewed and when, or client IP addresses (which can roughly approximate location). Depending on the structure of the URL of a referring site, additional information can be identified (e.g., where a user's search is included as a character string in a search engine referral address). Web server logs can also contain information as to which webpages a user has visited and the order of a user's traversal through a website.

Workflow data 232 may also include, in some embodiments, engagement data or site activity data regarding how users interact with a website or application. In an exemplary embodiment, this data could include any of click or view data on links, advertisements, images, listings, pages, and so forth, actions such as liking/disliking, bookmarking, saving, marking as favorite, adding or editing wishlists, scrolling, or other actions (or transactions) made by the user. In some embodiments, this engagement data may also include cumulative or calculated data based on the user's interaction with the website/app, such as an amount of time spent on a single page, listing, or website (or timestamps from which such time can be later determined), each visitation or view (from which a frequency of visitation or views can be later determined), referrals made, region(s) of searches and/or bookings or purchases, minimum, maximum, and median prices of the properties or products browsed, or any other relevant collected information. Additionally, in some embodiments, engagement data may include third-party data such as social media interaction with or regarding the website or app provider, such as shares, tags, comments, referrals, and the like (such third party data being collected from external servers 260. In some embodiments, activity data can be collected from server logs as users visit pages, from server application software which generates the requested pages, and/or by client software such as JavaScript or mobile applications that can detect user actions (e.g., hovering over images, watching videos, and/or tracking the amount of time particular areas of a listing or search results are displayed in the display area, among other things).

Survey data 233 may include data entered by the user into a customer support interface. For example, a user interface may be presented to the user in the form of a persistent survey, an after-event survey, an intercept survey, a messaging survey, an email survey, SMS survey, telephone survey, website or application form survey or a survey provided to the user via a social media application or website. This survey data (variously indicated in FIG. 2A as data 251-257) is collected via one or more APIs between the system 110 and other survey collection systems.

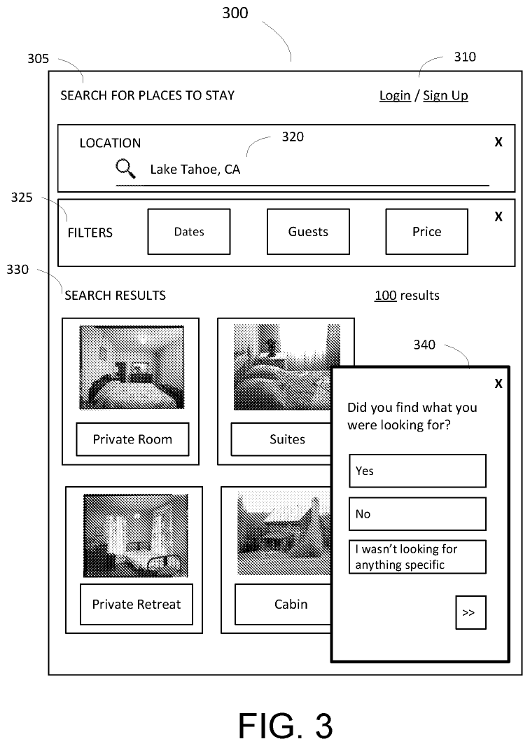

In an exemplary embodiment, the intercept survey is a freeform text survey present during the user's interaction with a computer system (e.g., on a website or application), presented before the initialization of a help ticket and without the need for default or generic questions in a post-event survey. Typically, these surveys are presented as a series of text questions and/or informational statements, to which the user can type their response. In an exemplary embodiment, a messaging survey through a chatbot application or window that hovers over content is presented to the user, e.g., the chatbot interface 340 in FIG. 3. As illustrated, chatbot interface 340 is a window presented to the user over the user interface 300 (the browser window or application). With reference to FIG. 2B, chatbot survey data 252 (or other survey data 251-257) may be associated with a unique survey or chat ID, which may be associated with the session ID and/or the user ID. In an exemplary embodiment, all content entered by the user into the survey interface, such as freeform unstructured text, selected structured text, hyperlinks, documents, or the like, is stored as survey data 233. This may include a last string (or selection) value or data. As described in greater detail below, one or more sentiment scores may be calculated during an interaction with the user. In one instance, a single sentiment score may be generated based on the last string (or input) entered by the user, or a last string sentiment score. In another instance, a delta sentiment score (or ΔSentiment) may be generated to indicate an overall sentiment score for an ongoing interaction with a user, which interaction may include one or more user inputs and/or one or more responses. Changes to this delta sentiment score (that is, whether the sentiment of the user is improving or declining, and the degree of change) may also be calculated and stored. In some embodiments, stored input, response, or combinations of one or more inputs/responses may be reduced and stored as vector data which can be better analyzed as described herein. Accordingly, survey data may contain one or more vector IDs to information stored as vector data 242. While in FIG. 2A vector data 242 is stored separately from database 230, in other embodiments the storage of vector data 242 may differ.

Ticket data 234 may involve information observed in or obtainable from various survey data 251-257 input by the user (stored in memory 210 as survey data 233), their account or workflow information, or the like. This ticket data is assigned or categorized into ticket categories (e.g., problems, topics, or features) that can be tracked at various levels of granularity. For example, multi-user and/or multi-session level analytics can be obtained from the ticket data to gauge reoccurring or severe issues experienced by users. Ticket data 234 may include for instance, one or more ticket IDs associated with customer support tickets. Customer support tickets may in some embodiments be created dynamically at the start of any communication between a user and customer support system 210, regardless of who and how that interaction was initiated (e.g., the presentation of a survey or chatbot to the user), or the initiation of a survey instance. Ticket data 234 may also include one or more of severity data, product ID data, feature or defect ID data (when associated with a software product), ticket topic data, and/or customer support history data organized by user. Severity data may be obtained or inferred from the content of the user's input itself (the structured or unstructured text of the survey response). Product data may also be so obtained, or may be dynamically inferred, e.g., from the particular user activity of the user. For instance, where the user has visited multiple account management and/or payment screens, the problem may be inferred to be one broadly related to payment, or even more narrowly related to, e.g., adding a new payment account. This category of “product” may in one example be dynamically inferred from this content of the user's textual customer service inputs, through a natural language processing (NLP) analysis that may include semantic classification (e.g., topic classification) based on feature extraction from freeform text. In some embodiments, a feature (possibly with a smaller scope) may be identifiable from the application of the machine learning algorithm.

Thematic response data 235 may include data generated by the system 110 that can be used in response to data input submitted by the user in a chat survey interface, such as a chatbot or messenger application. The term “thematic” is used herein to describe data that can be organized or associated with a topic (e.g., ticket topic), theme or classification. Such themes or categories are intended to conform with topics on which a user may seek customer support, that is, support topics. As one example, where system 110 is a customer support system for use with an website facilitating an online reservation platform, such themes or classifications may be, for instance, “user”, “user account”, “payment”, “booking”, “cancellation”, “confirmation”, and so on. Of course, the foregoing is merely exemplary, and different websites or applications, or other solutions, may require different breakdowns of categories. In some cases, the themes may conform to product names or IDs, features, software releases, testing efforts, or the like. Each theme may be identified by a unique theme classification ID.

As thematic response data 235 may contain all possible response data for display to the user, any subset of data, sharing a common classification ID, can be understood to contain all possible response data relating to the theme or classification in which the user is seeking customer support. For example, where the user is seeking support on a payment question or problem, system 110 may obtain from thematic response data 235 any or all of the set of possible responses regarding “payment”.

Each of these responses may be associated with a sentiment value, such that they may be associated with data identifying the response as a positive sentiment response, a negative sentiment response, or a neutral sentiment response. In general, it may be understood that a positive sentiment response would be presented to a user where the user input has been analyzed to determine that the user sentiment is currently or overall positive. Negative and neutral sentiment responses may be understood correspondingly. Thematic response data 235 may also contain threshold data that would define the boundaries or ranges under which a calculated sentiment score would be considered positive, negative, or neutral. Other embodiments may use different sentiment categorizations (e.g., strongly or mildly positive/negative, etc.). Finally, the thematic response data 235 may also contain suggested response data, that is, a “next” or “upcoming” response that is recommended to be presented to a user via the customer support interface (e.g., chatbot or messenger app), or other action to be taken, based on an evaluation of the context and sentiment of user input text.

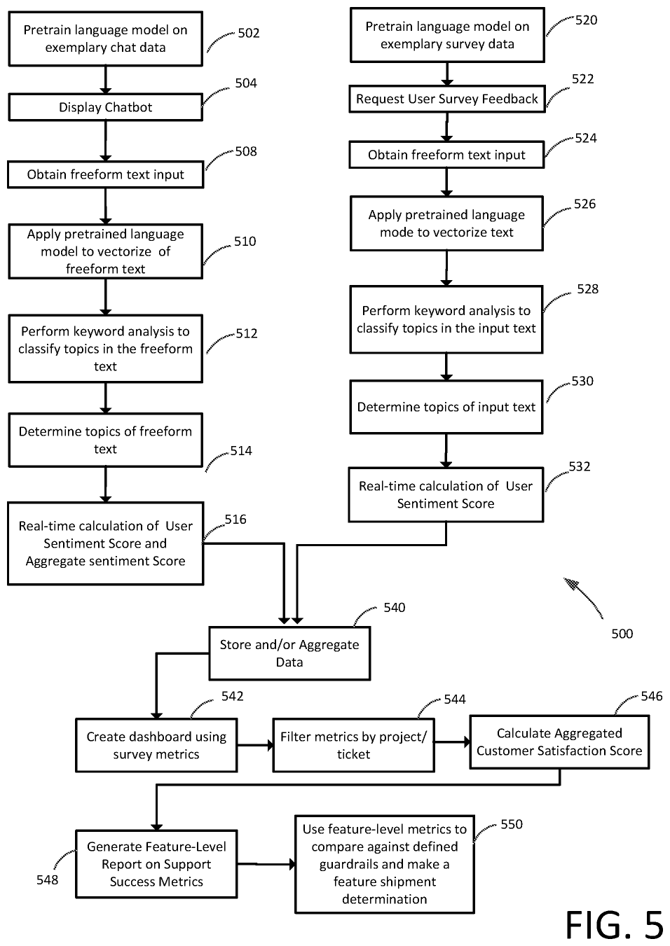

Information in vector data 242 may include information sufficient to uniquely identify one of more vectors or other encoded representations of a sentence, word, or character string generated from the freeform text data input by a user, as well as the one or more associated vector/encoded representations. This data is evaluated in real-time via one or more machine learning algorithms for purposes of content classification and/or sentiment analysis, in a manner described in greater detail below with respect to FIGS. 5 and 6.

In an exemplary embodiment, a chat-based survey is created and users may respond thereto, encapsulating implementation details of the underlying survey mechanism. The initial survey backend can store survey configuration and responses in a database or in another computer system with exports to memory 210 or data warehouse. That is, given freeform text entered by a user via an interface on a website (e.g., a chatbot or messenger) the user's sentiment can be derived in real-time, and appropriate actions can be taken or recommended to the user. This interaction is done before the initialization of a help ticket and without the need for explicit questions in a post-event survey. The derivation of user sentiment is performed through one or more machine learning algorithms, and the model-predicted sentiment can be used as a real-time indicator for customer satisfaction.

Exemplary embodiments are described herein with reference to FIGS. 3-6. With reference to some embodiments, a customer support system 110 may be understood as a system for taking in requests for customer support from users of a web-based interface, resolving the outstanding issues, either by assisting a customer in self-solve support actions or escalating through a systems-level support group, and/or generating metrics based on aggregated customer support data. The customer support system 110 may take a freeform text input string or query from a user and retrieve text-based (or in some cases, document or hyperlink-based) responses that have high topical relevance to the input string or query. The relative responsive content may in some embodiments be selected from within a larger corpus or collection of potential responses. The retrieval of this information is performed based on a holistic analysis of the user's textual input in the query. To accomplish this, one or more semantic classification models may be applied to the textual input. In an exemplary embodiment, such models may include a topic classification and/or intent classification model, implemented by example through a keyword extraction method. In an exemplary embodiment, such models also include a sentiment analysis to detect an overall satisfaction of the customer as well as a sense of urgency or importance. The returned responsive content may be one or more (or any combination of) textual responses, hyperlinks, download links, selection buttons, or the like, each respective response offering or seeking information that may assist with the resolution of the customer support issue. The returned responsive content need not be a uniquely generated response to the user's exact query (though it may be), and in some embodiments may instead be a predetermined response (from a database of responses) that is contextually-related to the user's query, while also being selected or modified based on the user sentiment analysis.

A holistic customer service feedback implementation is applied, collecting feedback from chatbot and other analysis, using the text feedback to classify sentiment, and assign different user satisfaction scores based on the sentiment analysis. With reference to FIGS. 3-6, one goal of the systems and methods described herein is to increase coverage of user feedback and to evaluate freeform text input to find implicit signals of customer satisfaction.

For example, in some embodiments, the systems and methods described herein are directed to the creation of a conversational survey for a chatbot to be presented on a website. The chatbot supports the output of survey questions and the intake of answers for the survey in a native chat format. In some embodiments, the systems and methods described herein are further directed to the collection and analysis of survey results. One or more dashboards to view metrics based on chatbot survey results may be generated. Engineers, data scientists, and and/or product managers can use these metrics (at different levels of types of aggregation) for feature experimentation. Dashboards can be created (or modification of an existing dashboard) to interact with the chatbot success metrics dashboard to understand customer feedback scores. Sentiment analysis may be conducted on survey freeform text inputs, and sentiment data may be derived. Feedback for individual responses may be obtained, e.g., complete, consolidated, or aggregated survey scores. This allows the user to filter and compare survey metrics across support topics.

FIG. 3 illustrates such a chatbot interface 340, superimposed so as to “float” or persistently remain on top of the website screen 300. In the example of FIG. 3, the user is using interface 300 to search for and book a temporary stay, such as a hotel or housing rental. The user may or may not have logged in (element 310), which log in would tie the user's session (designated by a session ID) to particular user account information stored as user data 231. The user may have engaged in search, navigational, or other activity during their session. For example they may have searched (field 320) a location, filtered (field 325) on any number of granular filters, such as date of stay, number of guests, price, and so on. The user may also have clicked on one or more of displayed results 330. Each of these navigational, click, search, or other interactions may be stored as workflow data 232 in association with a session ID (and/or in some cases, a user ID).

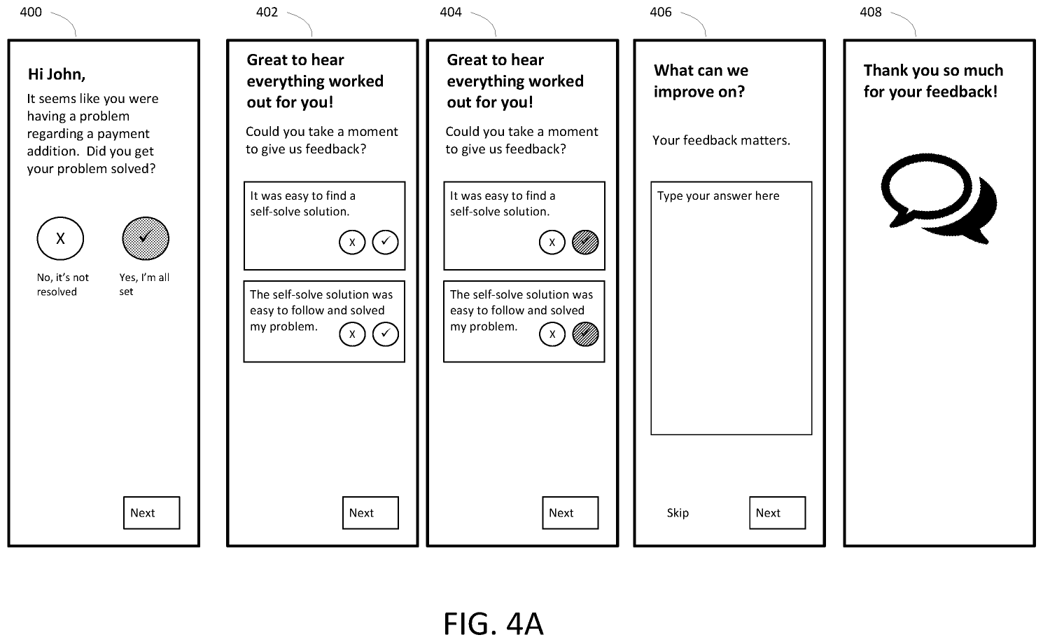

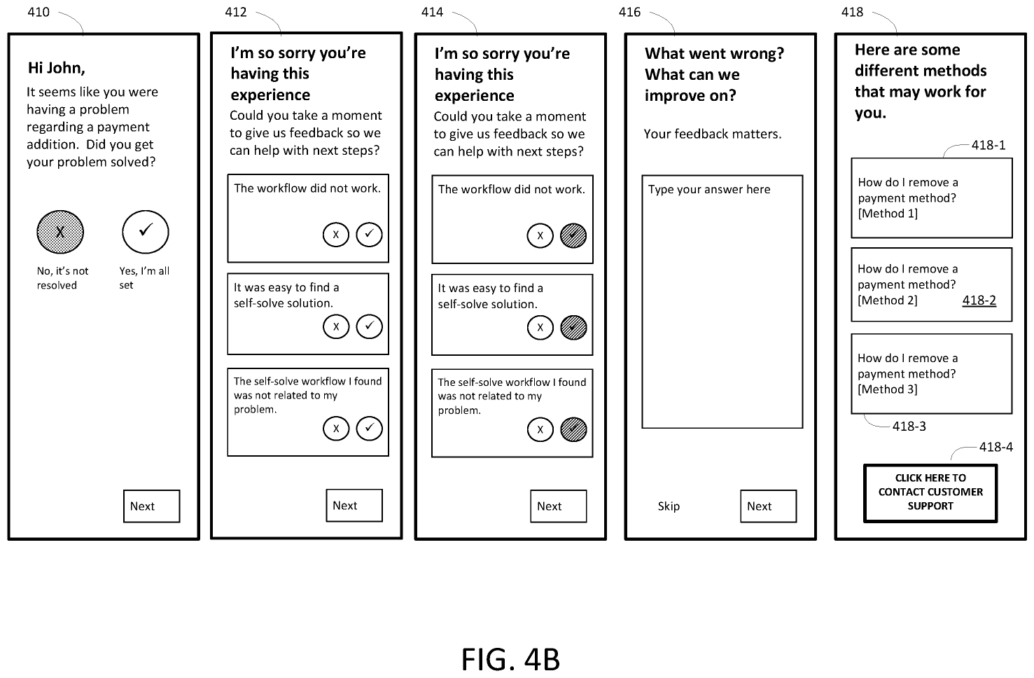

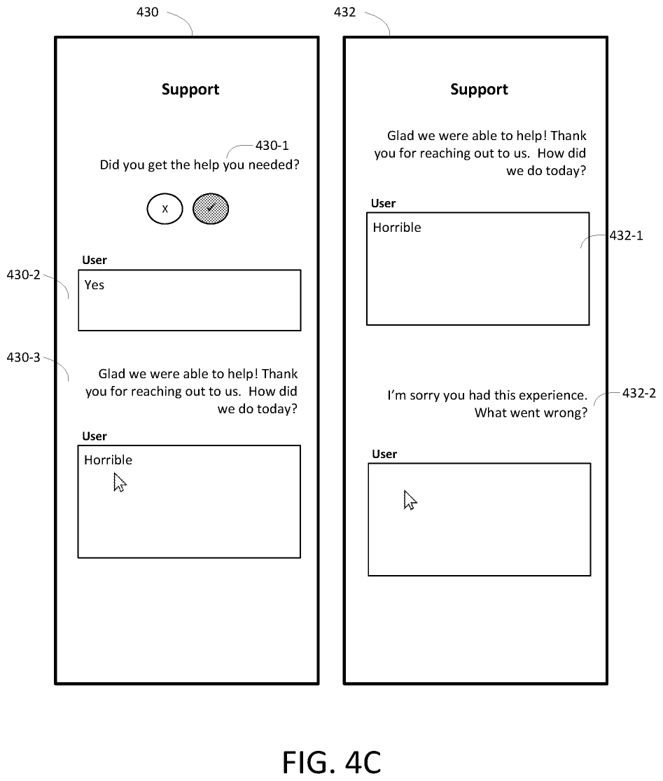

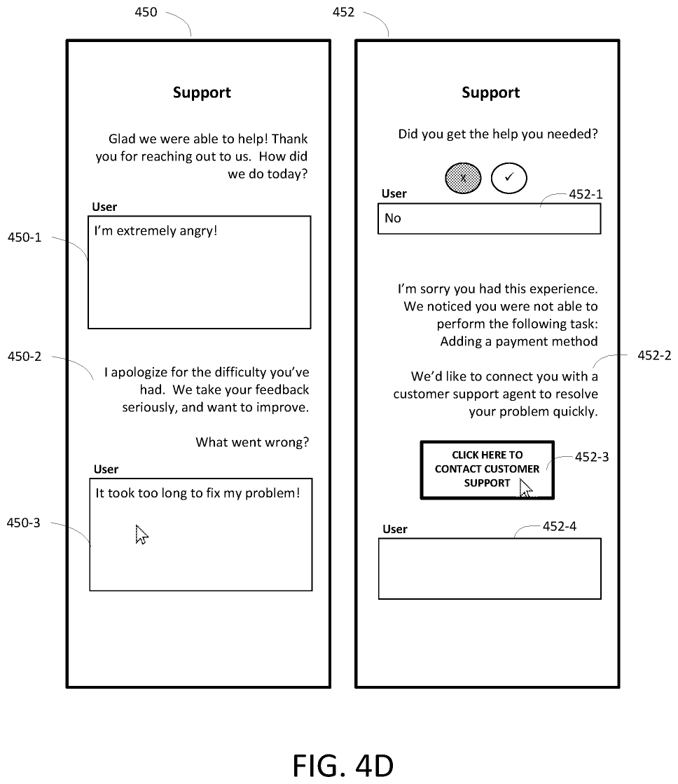

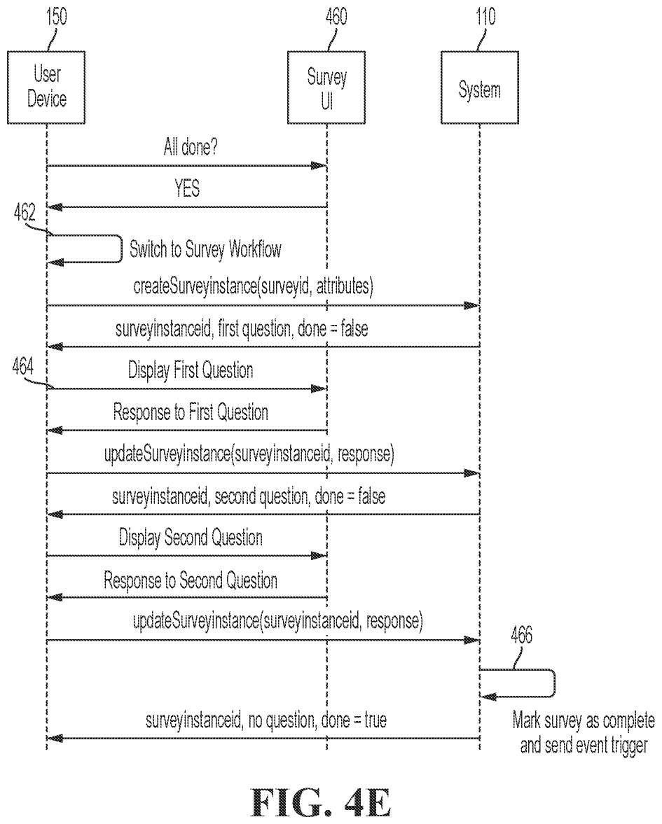

FIGS. 4A-4D describe various progressive survey interfaces that may be displayed to the user and updated in real-time, for example through a chatbot interface 340 or other similar type of interface. FIGS. 4A and 4B each depict a user interface (400 and 410, respectively) that inquire whether the user's problem was solved. These UIs may be generally understood as surveys presented during or after the user's workflow or progression through the website or application. In FIG. 4A, the user's problem was resolved, and a progression of screens is displayed in which system 110 requests additional information from the user (402), takes in additional input from the user (404), requests free-form text input with user feedback (406), and ends the interaction (408). In FIG. 4B, the user's problem was not resolved, and a different progression of screens is displayed, though the general process of requesting (412) and receiving (414) information, and requesting freeform input (416) remains. On UI 418, rather than ending the interaction, system 110 displays options for self-solve actions 418-1, 418-2, and 418-3, as well as a button 418-4 to facilitate escalation from a self-solve solution to an agent-implemented solution.

FIGS. 4A and 4B illustrates embodiments where customers provide feedback through a conversational chatbot survey. A customer interacts with a chatbot to obtain support. Upon completion of the customer's support interaction, confirmed by the customer selecting, in FIG. 4A, “Yes” for “Did you get the help you needed?” An action will then be invoked to determine if an after-support survey should be shown to the customer. If a survey is to be shown, a mechanism to invoke the appropriate survey for this interaction will be immediately returned and the customer will be able to interact with a survey through a messaging interface. After answering the first question in the survey, the response to that question will be recorded and the next question to ask as part of the survey will be returned and displayed within the messaging interface. When the end of the survey is reached, a message thanking the customer for their feedback will be displayed and the survey will be marked as completed.

In another embodiment, the customer starts but does not complete a survey. In such a case, a started survey will be marked as completed after a predetermined period of hours or minutes. After that time, any provided responses will be used in success metrics calculations. Metrics may be tracked around and distinguishing partially vs. fully completed surveys for analytics.

FIG. 4E illustrates one exemplary interaction between the user device 150, a survey UI (chatbot 460) and the system 110. Upon an initial determination that the user is done with their workflow, the process switches to a survey workflow (462), in which a series of questions (464) may be transmitted to the user in between generation and updates of the survey instance. When the survey is complete (here, after receiving a response to the second question), the system 110 marks the survey as complete (466) and sends an event trigger to save/aggregate metrics, initiate an alternate work or other remedial action.

Other example user interfaces are illustrated with reference to FIGS. 4C and 4D, which depict user interfaces presented to a user at the end of, or subsequent to, a workflow. These UIs may be generally understood as post-event surveys, which are intended for feedback purposes rather than to drive workflow in the immediate session. In FIGS. 4C and 4D, rather than a progression of screens, the illustrated UI is a scrolling interface, as with modern chat or text messenger applications or widgets. As additional input and response is transmitted and displayed, the newer responses are added to the bottom of the chain.

The screens of FIGS. 4A-4D are merely exemplary. The particular form of the input mechanism, e.g., via website, intercept or post-action survey form, chatbot or other bot, messenger app, text entry widget, text message or SMS, and so on, is unimportant so long as the response can be received any processed in real-time. Accordingly, the user interface through which the input is received may be arranged in any suitable manner and with any appropriate elements in various embodiments.

FIG. 5 depicts an exemplary sentiment analysis process 500 performed by the sentiment analysis logic 124 and the autoencoder 240, in combination with feedback aggregation logic 220 or other components of customer support system 110 in accordance with some embodiments of the present disclosure. In general it may be understood that the exemplary process 500 is intended to address two problems preexisting in the conventional solutions: first, how to measure the sentiment (and changing sentiment) behind a user's real-time customer support feedback, and second, how to act upon and use such measurements in a meaningful way. The first problem is addressed by measuring implicitly the sentiment behind what is typed during a user's interaction and input of freeform text rather than (or in complement to) a post-action survey. The second problem is addressed by holistic analysis of sentiment using data collected at multiple source points and through aggregation of users to determine which products or features to ship.

The process begins at preliminary steps 502 and/or 520 in which one or more machine learning models have been trained on training sets. In step 502, the training set is a set of character string data simulating potential input text typed in by a user. In step 520, the training set is an exemplary or curated set of customer survey data from a variety of different sources 251-257. This training data in steps 502 and 520 may encompass text directed to a variety of topics and a variety of languages, formality of speech, and so on, so as to provide a variety of possible input text. In one embodiment, the training set may include 10,000 or more data points in 9 different languages. Each set of training data may be vectorized and machine learning algorithms applied. A vector may be understood to represent a variety of information about a sentence. This may include any or all of, e.g., semantic characteristics (what the sentence means), the tokens (words and/or punctuation) in the sentence and what they mean in the context of each other and in the sequence of tokens, and other appropriate contextual information. This vector data is stored to memory 210 and/or to disk, depending on the size of the dataset and the computational limits of the system 110. The machine learning models extract features from this training data to develop one or more trained models capable of sentiment analysis and topic classification. In an exemplary embodiment, NLP (natural language processing) models may be trained on the training set on a periodic or scheduled basis, for instance daily, weekly, monthly or the like, or in real-time, depending on the size of the collection and the frequency of relevant change within that collection, to optimize the weighting applied by the various ML (machine learning) models applied to the systems described herein. The training generates a pre-trained model that can be used in a run-time application to pre-compute representations for individual, varied length sentences in a dataset which can be used in subsequent steps, such as measurements of sentiment.

The process after step 502 will be described first. In step 504, a user interface (chatbot) is displayed to a user. A freeform text input (query) by the user is obtained in response in step 508. This input by the user is received in real-time, so the system 110 may, in some embodiments, be consistently listening to determine whether text entry has ceased.

In one embodiment, control logic 222 and/or communication logic 224 are executed by processor 245 in step 504 to provide to web server 140 a graphical user interface to be displayed on user device 150. Web server 140 may present to the user device 150 a user interface through which input data can be accepted. FIGS. 3-4D illustrate exemplary user interfaces through which a variety of input can be entered by the user of device 150. Web server 140 (or a component of system 110) may extract, from the input data, various information about the input text and/or other values including, in an exemplary embodiment, the actual content of the query input string (in some embodiments, in a tokenized format). In addition to freeform text data entered, the data obtained from web server 140 may also variously include information sufficient to identify the user, such as a user ID (if the user is logged in or otherwise authenticated) or a session ID, as well as the particular text input by the user. The input text is transmitted from the web server to customer support system 110 and processed by the autoencoder 240, sentiment analysis logic 124 and/or feedback aggregation logic 220.

In step 510, the pretrained ML model is applied to the input text as to the text of the training set, and vector representation(s) of the text input is generated. The autoencoder 240 is applied in step 510 to generate a series of vector representations from and representing textual sentences or phrases. In some embodiments, a corpus of text is stored as individual string inputs in memory 210, for example as survey data 233, or in a separate memory or hard disk. In an exemplary embodiment, autoencoder 240 vectorizes every input string stored in survey data 233. The vector representations are then stored in memory 210 (or in a separate memory or hard disk) as vector data 242, each vector being stored in association with a unique vector ID relating to the vector to its initial input string. The specific method of generating the vector from the textual input may be performed through any of a variety of known methods. In one exemplary embodiment, Google's BERT (Bidirectional Encoder Representations from Transformers) model or a model based on BERT, such as XLM-RoBERTa, may be used as an applied natural language processing (NLP) model. However, in other embodiments, any other appropriate pre-trained model (e.g., Generative Pretrained Transformer (GPT), Text-to-Text Transfer Transformer (T5), ULMFiT, etc.) may be used.

Steps 512 and 514 are directed to the application of machine learning models to classify topics and analyze sentiment respectively, based on the text input by the user in step 508. In step 512, a topic classification is performed to determine the semantic meaning of the input text. In one embodiment, the user may, in a plain text sentence, phrase, or passage, reference a concept or description connecting the input to a particular scenario, circumstance, product, problem type, or the like. Rather than a Boolean search or filtered search (e.g., where the user selects keywords, categories, or characteristics), a machine learning analysis is performed on the free entry of text in the user's natural language. This input may be used by sentiment analysis 124 to obtain from a database one or more responsive text results that are contextually related to the content of the freeform input, without having to identically or explicitly match word-for-word content in such stored data.

In an exemplary embodiment, text classification or topic extraction from text is performed by one or more supervised or unsupervised algorithms, preferably, at least one multi-lingual model although any model used may be trained on multi-lingual or monolingual data. In some embodiments, this may involve feature extraction from freeform text e.g., to generate vectors for words or sentences (step 512). Topic classifiers are defined in advance, and stored in memory 210 as thematic response data 235. As examples, some predefined topics may include: “user account”, “payment”, “booking”, “cancellation”, “confirmation”, and so on. The specific topics can be generally understood to be specific to the purpose and use of the website or application. In some embodiments, the predefined topics may correspond to products, ticket topics or identifiers, or other delimiters created by a backend customer support system. For each of these topics, one or more machine learning models may be applied to detect patterns in the input freeform text that suggest relevance. For example, for “payment”, the models might detect patterns such as currency symbols, numbers, related words such as credit/debit, expensive/cheap, refund, bank, worth, price, account, and/or combinations of words in particular relevant order and/or structure. The models would then label the corresponding text in the input string appropriately. In some embodiments, exemplary algorithms are NLP topic classifications models such as Latent Semantic Analysis (LSA), Latent Dirichlet Allocation (LDA), and/or other text classification algorithms such as Naïve Bayes, Support Vector Machines (SVM).

As an output of step 514, one or more topic classifiers may be assigned to the user input string. The topic analysis may be applied at one or more of a sentence level (i.e., for each individual input by the user), at the field level (i.e., for the whole of a single query or response entered in an input field by the user in a back-and-forth conversation via a chatbot or messaging app, or in another written survey response). In some embodiments, the topic analysis may additionally be applied at the session level, where the topics defined by the user's text input are refined, altered, rewritten, or otherwise revisited in view of the holistic whole of the inputs by the user during the session.

In an alternate embodiment, an unsupervised machine learning technique may be use to cluster expressions and derive topical relevance without predefinition of topic tags. In other embodiments, rather than a machine learning technique, one or more rules-based systems may be applied to perform a topic classification task, for example by using predetermined lists of words associated with topic classifiers and recognizing the presence or absence of such words in the user's input. In still another embodiment, a topic of the user's input may be actively selected by the user from a presented set of topics displayed on the user interface, e.g., as selectable buttons.

In some embodiments, the ML models described above are not limited to the text input by the user and may additionally or alternately use historical data regarding the user's prior interactions with the system 110. For instance, in a first customer support instance, a tone (or style) of response (e.g., language, formality, linguistic traits) may be detected, and an identifier for such a tone of response may be stored in memory 210 in association with user data 231. Upon the initiation of a subsequent session with the same user (recognized, e.g., by login information, IP address, device ID, or so on), these identifiers may be accessed and used to evaluate text responses presented to the user. Additionally, other user profile data (such as location data (e.g., device of IP data), demographic data, prior customer support history (e.g., frequency of problems), and so on) and other circumstantial data (such as time of day/night, location of purchase or booking, type of device used for interaction, and so on) (e.g., user data 231) may feed into recognition of a type of issue. As just one example, in the case of a website that facilitates property bookings, it may be assumed that a user logging in from a home computer several weeks in advance of a booking may have a different type of query than a user logging in late at night from a mobile device or borrowed device on the evening of a booking, even where both users use similar words in their query, such as “payment” or “confirmation”. These additional factors may be considered within the ML models described above, for example in a weighted regression analysis where the sentiment analysis of the written text is weighted more strongly than circumstantial factors.

In step 516, a sentiment analysis is performed on another vector representation derived from the freeform text input, or in some embodiments the generated same vector(s) used in step 514. Every time the user interacts with the interface, thereby providing more input data to the web server 140, a sentiment analysis is performed to derive signals regarding user sentiment. This sentiment analysis is conducted via NLP methodology based on the user's freeform text entered into a chatbot. For each user response, a sentiment score is determined. That is, a sequence of sentiment scores is obtained at a fine level of granularity, and can be used at different levels of aggregation. For example, delta changes in sentiment can be obtained over the course of a chat conversation. Therefore, for example, over the course of an interaction, with several back-and-forth communications between the user and system, a user's sentiment can be measured to improve, and by what degree. Lowered sentiment can be compared to a bottom threshold value or limit, and when that limit is exceeded (e.g., the value falls below the threshold), the system may understand the customer support efforts to be upsetting or unsatisfactory to the user. In an embodiment where a survey may be conducted after a customer support activity is complete (e.g., by email or text, social media or form submission), this real-time sentiment analysis during chat interaction is performed in addition to, and is not a replacement of a subsequent survey.

In an exemplary embodiment, sentiment analysis from text is performed by one or more supervised or unsupervised algorithms. In an exemplary embodiment, a transformer-based deep learning technique is used for sentiment analysis and other large scale NLP processing tasks. The transformer may be trained on the dataset described above with regard to step 502. Exemplary transformer models may include XLM-RoBERTa, or other models based on BERT. In some embodiments, sentiment analysis task is modeled as a classification problem, whereby a classifier is fed a text input and returns a category, e.g. positive, negative, or neutral. This may involve feature extraction from freeform text e.g., to generate vectors for words or sentences. Exemplary classification algorithms are NLP classification models such as Naïve Bayes, Support Vector Machines (SVM), and/or linear regression techniques. The output of the models is a probability distribution across different sentiment categories, then a sentiment score is generated based on the distribution. In some embodiments, this score may then be compared to a range of possible scores to classify the sentiment as positive, negative, or neutral. In other embodiments, other classification schemes may be used, e.g., highly/slightly positive/negative. In an exemplary embodiment, the sentiment score is a value from 0-1, with 0 being the most negative, and 1 being the most positive.

The calculation of such a sentiment score is performed in step 516. Each time the user submits an additional character string, a real-time sentiment analysis may be performed thereon and a sentiment score may be calculated to reflect the user's current satisfaction or happiness. Where more than one text input has been submitted by the user (that is, second and subsequent inputs), step 516 may also involve the calculation of a delta sentiment (Δsentiment) or change in sentiment after the submission of each input. This delta sentiment value reflects a change in sentiment between the previous user input and the most recent user input. Where the value is positive (or above a certain threshold), the user sentiment is considered to improve. Where the value is negative (or below a certain threshold), the user sentiment is considered to have degraded (i.e., the user's experience is worsening and they are being increasingly unhappy). Where the value is zero (in within a predetermined range), the user sentiment is considered to have remained stable. The delta sentiment value reflects a trend in sentiment over the course of the interaction. In some embodiments, the delta sentiment score is overwritten when each subsequent input is evaluated, and in other embodiments, a series of delta sentiment scores is retained and stored in memory 210, so that the user's changing satisfaction can be evaluated over a longer period of time.

In yet another embodiment, an aggregate user sentiment score is maintained in memory 210 and updated in view of the newly-determined user sentiment. The aggregate user sentiment score may be any of, for instance, an average score, the latest calculated score, a series or chain of scores, or any other appropriate value that would reflect an overall user sentiment for the interaction.

In other embodiments, rather than a machine learning technique, one or more rules-based systems may applied to perform a sentiment analysis task, for example by using predetermined lists of words associated with sentiment classifications (positive, negative, neutral) and recognizing the presence or absence of such words in the user's input, or other linguistic NLP methods.

In some embodiments, the ML models described above are not limited to text directly input by the user into the chatbot and may additionally or alternately use historical data regarding the user's prior interactions with the system 110. For instance, in a first customer support instance, a tone (or style) of response (e.g., language, formality, linguistic traits) may be detected, and an identifier for such a tone of response may be stored in memory 210 in association with user data 231. Upon the initiation of a subsequent session with the same user (recognized, e.g., by login information, IP address, device ID, or so on), these identifiers may be accessed and used to tailor the tone of text responses presented to the user. These additional factors may be considered within the ML models described above, for example in a weighted regression analysis where the sentiment analysis of the written text is weighted more strongly than circumstantial factors.

In another example, and as described in greater detail herein, the user's session and historical data (e.g., user data 231 and/or workflow data 232) may be used to analysis sentiment, for example screens viewed, buttons pressed, past user purchases, user profile data, including demographic, location and language data, and other such historical and contextual metadata related to the user. Still further, where the website or application with which customer support system 110 is used has other messaging or communication functions (such as chat between members, seller/purchaser, booker/bookee, host/guest and so on, data from text-based threads indicating interactions between these entities may also be used in an analysis of the customer's sentiment. However, in an exemplary embodiment, because a human user's sentiment may change over time, data that is temporally closer to the customer support interaction, such as session activity or workflow may be considered to be more convincing and therefore weighed more heavily than other factors.

Additionally, other user profile data (user data 231) can be used to tailor speech, such as location data (e.g., device of IP data), demographic data and so on. Accordingly, a specifically tailored experience can be provided to a user of a customer support system without the user having to evaluate and select questions to trigger a certain response from the system. Additionally, users who speak multiple or non-local languages, may be afforded better communication and more valuable information in their customer support interaction.

Steps 520-532 are analogous to steps 502-516, however, rather than a chatbot, other survey data is used. For instance, any of survey data sources 251-257 may be relied upon for the collect (step 524) and analysis (steps 526-532) of the content and sentiment expressed therein. At the output of steps 532 and 516, at least one user sentiment store has been calculated for all user feedback provided via survey data across a plurality of channels between the customer device 150 and the system 110.

In an exemplary embodiment, it is possible for the determination of user sentiment to be predicated on additional data beyond the input text itself. For instance, where the user may (based on their user data/login) be associated with external websites or social media accounts, user-entered text in those mediums may be collected and stored as user data 231 and weighed as another factor in the ML algorithms applied by sentiment analysis logic 124. As just one example, if a user expresses a negative opinion on a public social media application, such data can be collected (e.g., periodically) from external databases 260, and the sentiment analysis logic 124 may thereafter assume that the user begins their interaction with an overall negative sentiment.

Where appropriate, one or more of thematic response data 235 can be selected and displayed to the user in a real-time communication (not shown in FIG. 5), in view of the calculated topic and sentiment data. An exemplary difference in possible responses based on a sentiment determination can be seen with reference to FIGS. 4C and 4D. FIG. 4C's snapshot 430 of the UI illustrates a collection of feedback that asks primarily for freeform text input. After an initial inquiry of whether a problem was solved (430-1), the screen receives a user input of “yes” (430-2), or in other embodiments, a selection of a button indicating a positive or negative response. Based on input 430-1, the NPL models of sentiment analysis logic 124 may determine that the user sentiment is positive, and may select from thematic response data 235 a positive response (430-3). As shown on screen 432, in response to text 430-3, the user inputs a text string of “Horrible” (432-1). Based on a real-time sentiment analysis of the response, the sentiment analysis logic 124 may defer from its planned series of inquiries, and instead select from thematic response data 235 a “negative” response (432-2), or more specifically, an apologetic or problem-solving response. This negative response 432-2, contains language (“sorry”) that is tailored to the user expressed sentiment. In screen 450 of FIG. 4D, the user's initial input (450-1) can be interpreted by sentiment analysis logic 124 to express a strong negative sentiment. In such a case, the suggested user response (450-2) from thematic response data 235 that is displayed on screen 450 is tailored from the outset to the client's negative sentiment and provides the client with an opportunity to enter freeform text (450-3) to describe the reason for the client's negative sentiment. In screen 452 of FIG. 4D, the user's initial input (452-1) in response to an inquiry as to whether the client received the help that was needed is received. The user's input 452-1 can be one or both a user input of “No” and a selection of a button indicating a negative response. The sentiment analysis logic 124 can interpret the user's input 452-1 to express a negative sentiment. In such a case, the suggested user response (452-2) from thematic response data 235 that is displayed on screen 452 is tailored from the outset to the client's negative sentiment (e.g., a “negative” response, or more specifically, an apologetic or problem-solving response). In addition, rather than ending the interaction, system 110 displays an option (e.g., a button) to facilitate escalation from a self-solve solution to an agent-implemented solution (452-3) or to provide additional commentary on the situation (452-4). Of course, the text and responses shown in these figures are merely exemplary and other embodiments may differ.

By virtue of the sentiment analysis processes described herein, a chat point can be presented to the user and signal measurement can be performed based on the customer support interaction itself, and both the quality of questions/response and of customer satisfaction can be improved in real-time. The results of this method are more effective than that of conventional decision trees, where selections guide the process down different branches until a resolution point is reached (and the process restarted if not successful), or later submitted complaints or customer support calls. Further, additional information can be considered in both the dynamic generation of questions to ask the user as well as the form and linguistic expression to be used in asking them. The user's freeform responses can be used to dynamically reevaluate the questions to be asked.

In an exemplary embodiment, the surveys presented to the user in steps 522 and 524, though not specific to a chatbot source, are powered by similar functionalities as described above. That is, such surveys might ask the customer various questions to determine how successful the customer support agent or system was in solving the customer problem and how satisfied the customer was with the support experience. As with the above-described real-time chatbot interaction, the questions to be presented in a customer survey may be selected and tailored in view of the calculated user sentiment, historical user interactions, session workflow data, user demographic data, and so on, in a manner similar to that described above in the context of acting upon a sentiment analysis.

Turning back to FIG. 5, once survey information has been analyzed and sentiment data collected (Steps 516 and 532), steps 540-550 follow to collect, aggregate, and apply sentiment analysis in the generation of survey metrics. Such collection and aggregation may be performed by feedback aggregation logic 220, beginning in step 540. More specifically, a set of various conversational APIs for receiving survey questions and collecting responses is presented to a user. This may include, for instance survey data from intercept surveys 251, chatbot surveys 252, email surveys 253, SMS surveys 254, telephone surveys 255, website or application form surveys 256 and/or social media surveys 257 or any subset thereof. Survey results from any or any subset of these sources is exported into a data repository (memory 210 or another warehouse or storage). These data pipelines to collect alternate feedback sources across multiple channels are established and managed by feedback aggregation logic 220. Similar and related data is collected across a plurality of channels (here, in steps 516 and 532, though other embodiments may use any number of channels), and the data is normalized into a format that enables comparison of customer satisfaction and support outcomes metrics across channels.

In step 542, a dashboard (e.g., a web-based dashboard) is generated using the collected survey metrics. These metrics may be filtered upon (step 544), e.g., by an engineer or business leader, based on a project, feature, or topic relevant to the customer base. Because ticket topics have been associated with each respective user input (steps 514, 530), there is a high level of granularity and dimensionality that can be achieved in a sentiment analysis. Customer sentiment can be calculated on a user level and/or a topic level, for example, sentiment can be determined on all tickets saved or all tickets of a certain type, and an aggregated customer satisfaction score can be calculated (step 546). The discovered ticket topics (content topics) may in some cases be representative of tested products or features. Thus, sentiment can be tracked across various discrete sets of users or responses to evaluate user engagement and satisfaction. For instance, it would be possible to see a particular group of customers that are most satisfied by a product or feature, and to find similarities among those customers. Based on these steps, a more holistic view of customer perception can be obtained, and customer satisfaction with various products and channels can be analyzed and visualized with a high degree of accuracy, with the key metric being the customer sentiment generated from the customer's own language.

Step 548 involves the generation of a feature-level report on the support success metrics, for example as a document or user sentiment metadata for export. Such reporting would be most usual and valuable in a testing environment where certain features (or products) have been rolled out to all or a subset of customers. These feature-level metrics can be applied, in step 550, in a determination of the impact of such features to overall customer satisfaction (and therefore customer support success). Based on this evaluation, it can be determined whether the features fall within certain customer satisfaction guardrails. That is, if customer satisfaction at the feature-level is not sufficiently high to surpass the guardrails, an automated recognition may be triggered that the feature should not be launched, shipped, or deployed to customers in its current form, and such shipment may be automatically delayed or withheld. Accordingly, customer sentiment may be tied to software development and release cycles in an automated manner.

In conventional solutions, surveys were conducted through human-to-human interaction via guest complaint, customer support calls, and/or subsequent customer surveys. The response rate and quality of feedback achieved by these surveys is minimal, and is skewed toward negative responses. Because customer sentiment changes rapidly, these late-received feedback responses typically do not accurately reflect true customer feedback. Further, because the feedback is only considered after the fact, problems experienced by a user cannot be avoided or mitigated.

In contrast, the systems and methods described herein provide a single platform that manages and administers surveys through different support sources and channels to obtain customer feedback at various levels of granularity. Further still, customer workflows can be inferred and additional signals, such as customer sentiment, can be collected directly from and during a support interaction and/or other text-based survey data. These signals and workflows can be analyzed in real-time using NLP analysis, and tailored questions and responses can be provided to the user in real-time in a manner and language that is accessible to them, without delay and without changing medium. Further still, the systems and methods described herein allow for the ability to expose, aggregate and analyze the collected data in the analytical tools and processes used by business, operations, community support ambassadors and product teams. Additionally, the systems and methods provided herein consider in real-time customer satisfaction implications of a tested product or feature without any necessary price-modification experiments. Such an outcome is impossible in conventional solutions. Additionally, the amount of historical and contextual data that can be considered as part of this analysis could not be processed and analyzed on pen and paper or by the human mind at the scale and speed permissible by the machine learning solutions where actual real-world effects must be observed and recorded over a period of days, weeks, or months.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process parameters (e.g., dimensions, configurations, components, process step order, etc.) may be made to further optimize the provided structures, devices and methods, as shown and described herein. In any event, the structures and devices, as well as the associated methods, described herein have many applications. Therefore, the disclosed subject matter should not be limited to any single embodiment described herein, but rather should be construed in breadth and scope in accordance with the appended claims.

What is claimed is:

1. A method for projecting customer satisfaction with a feature to be added to a software product, the method comprising:
collecting, by a web server, one or more customer inputs via one or more user interfaces, the one or more customer inputs comprising one or more character strings;
determining, for each respective input of the one or more customer inputs, that the respective customer input is related to the feature to be added to the software product;
calculating a respective customer sentiment score for the one or more customer inputs through an application of one or more natural language processing (NLP) algorithms;
storing each customer sentiment score in a memory in association with information sufficient to identify the feature;
obtaining, from the memory, one or more customer sentiment scores stored in association with the information sufficient to identify the feature;
generating, based on the one or more customer sentiment scores, an aggregated customer satisfaction score for the feature;
comparing the aggregated customer satisfaction score to one or more guardrail values stored in the memory; and
in response to the comparing, causing the feature to be added to a future release of the software product.

2. The method of claim 1, wherein the one or more customer inputs are collected from at least one of: an intercept survey, a messaging application, a chatbot, an email survey, an SMS survey, a telephone survey, a social media application survey, a website form survey, or an application form survey.

3. The method of claim 1, wherein the one or more customer inputs are collected from two or more of: an intercept survey, a messaging application, a chatbot, an email survey, an SMS survey, a telephone survey, a social media application survey, a website form survey, or an application form survey.

4. The method of claim 1, wherein the one or more customer inputs are collected from a chat application permitting real-time exchange of text between a user device and a remote system, wherein the one or more customer inputs are provided as freeform text entry into the chat application by a customer.

5. The method of claim 1, wherein the calculating of the customer sentiment score for the one or more customer inputs comprises: applying one or more natural language processing (NLP) models to perform a sentiment analysis of the character string.

6. The method of claim 1, wherein the calculating of the customer sentiment score for the one or more customer inputs is based on a user's session workflow.

7. The method of claim 1, wherein the calculating of the customer sentiment score for the one or more customer inputs is based on demographic data associated with the customer.

8. The method of claim 1, wherein the one or more customer inputs are collected from a variety of channel sources including one or more of: website, a social media application, SMS, voice, e-mail, and chat application.

9. The method of claim 1, wherein the calculating a respective customer sentiment score for the one or more customer inputs comprises:
generating, for each of the one or more customer inputs, a vector encoding through an application of one or more natural language processing (NLP) algorithms; and
calculating, from each of the vector encodings, a respective customer sentiment score for the one or more character strings.

10. A method comprising:
collecting, by a web server, one or more customer inputs via one or more user interfaces, the one or more customer inputs comprising one or more character strings;
determining, for each respective input of the one or more customer inputs, that the respective customer input is related to a customer support topic;
calculating a respective customer sentiment score for the one or more customer inputs through an application of one or more natural language processing (NLP) algorithms;
storing each customer sentiment score in a memory in association with information sufficient to identify the customer support topic;
obtaining, from the memory, one or more customer sentiment scores stored in association with the information sufficient to identify the customer support topic;
generating, based on the one or more customer sentiment scores, an aggregated customer satisfaction score for the customer support topic;
transmitting, via the web server, a dashboard user interface comprising the aggregated customer satisfaction score for the customer support topic.

11. The method of claim 10, further comprising:
comparing the aggregated customer satisfaction score to one or more guardrail values stored in the memory; and
generating, in response to the comparing, causing a feature to be added to a future release of a software product.

12. The method of claim 10, wherein the customer support topic is a planned feature of a software product or service.

13. The method of claim 10, wherein the one or more customer inputs are collected from at least one of: an intercept survey, a messaging application, a chatbot, an email survey, an SMS survey, a telephone survey, a social media application survey, a website form survey, or an application form survey.

14. The method of claim 10, wherein the one or more customer inputs are collected from a chat application permitting real-time exchange of text between a user device and a remote system, wherein the one or more customer inputs are provided as freeform text entry into the chat application by a customer.

15. The method of claim 10, wherein the calculating of the customer sentiment score for the one or more customer inputs comprises: applying one or more natural language processing (NLP) models to perform a sentiment analysis of the character string.

16. The method of claim 10, wherein the calculating of the customer sentiment score for the one or more customer inputs is based on a user's session workflow.

17. The method of claim 10, wherein the calculating a respective customer sentiment score for the one or more customer inputs comprises:
generating, for each of the one or more customer inputs, a vector encoding through an application of one or more natural language processing (NLP) algorithms; and
calculating, from each of the vector encodings, a respective customer sentiment score for the one or more character strings.

18. A system comprising:
a memory configured to store one or more vector encodings of textual data; and
at least one processor configured to:
collect, by a web server, one or more customer inputs via one or more user interfaces, the one or more customer inputs comprising one or more character strings;
determine, for each respective input of the one or more customer inputs, that the respective customer input is related to a feature to be added to a software product;
calculate a respective customer sentiment score for the one or more customer inputs through an application of one or more natural language processing (NLP) algorithms;
store each customer sentiment score in the memory in association with information sufficient to identify the feature;
obtain, from the memory, one or more customer sentiment scores stored in association with the information sufficient to identify the feature;
generate, based on the one or more customer sentiment scores, an aggregated customer satisfaction score for the feature;
compare the aggregated customer satisfaction score to one or more guardrail values stored in the memory; and
in response to the comparing, cause the feature to be added to a future release of the software product.

19. The system of claim 18, wherein the at least one processor is configured to:
generate, for each of the one or more customer inputs, a vector encoding, the generating being performed through an application of one or more natural language processing (NLP) algorithms; and
calculate, from each of the vector encodings, a respective customer sentiment score.
